(19) United States
(12) Patent Application Publication
(10) Pub. No.: US 2007/0020003 A1
(43) Pub. Date: Jan. 25, 2007

(54) Fixing unit and image forming apparatus having the same

(75) Inventors: Dong-kyun Kang, Suwon-si (KR); Jae-hyeok Jang, Seoul (KR); Seung-jun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/483,559

(22) Filed: Jul. 11, 2006

(30) Foreign Application Priority Data
Jul. 20, 2005 (KR) 10-2005-0065671

(51) Int. Cl. G03G 15/20

(52) U.S. Cl. 399/328

(57) ABSTRACT

A fixing unit and an image forming apparatus are provided. The fixing unit applies heat and pressure to a print medium on which a toner image is formed and fixes the toner image on the print medium. The fixing unit includes a heating roller including a heating source, at least two pressurizing rollers which are pressed against the heating roller along an outer circumferential surface of the heating roller, adhesion elastic bodies which elastically press the pressurizing rollers toward the heating roller at first locations of both ends of the pressurizing rollers, and correction elastic bodies which elastically press the pressurizing rollers at second locations of both ends of the pressurizing rollers in the opposite direction of the adhesion elastic bodies. With this structure, the fixing unit forms sufficient fixing nips to reliably fix toner images on the print medium while maintaining a compact structure. Furthermore, this structure increases the life span of the apparatus by minimizing deformation of the pressurizing roller.

### CROSS-REFERENCE TO RELATED PATENT APPLICATION

This application claims the benefit under 35 U.S.C. § 119(a) of Korean Patent Application No. 10-2005-0065671, filed on Jul. 20, 2005, in the Korean Intellectual Property Office, the entire disclosure of which is hereby incorporated by reference.

### BACKGROUND OF THE INVENTION

1. Field of the Invention

The present invention relates to a fixing unit and an image forming apparatus having the same. More particularly, the present invention relates to a fixing unit that includes at least two pressurizing rollers and an image forming apparatus having the same.

2. Description of the Related Art

In general, an image forming apparatus forms a latent image by irradiating light on a photosensitive drum charged to a predetermined potential, develops the latent image formed on the photosensitive drum using a toner to form a visible image, transfers the visible image onto a print medium, and fixes the visible image onto the print medium, thereby printing a desired image.

A conventional fixing unit has two rollers, a heating roller having a heating source and a pressurizing roller. The pressurizing roller contacts the heating roller with a predetermined pressure to form a fixing nip along a longitudinal direction of the roller. To ensure that the fixing nip is of a sufficient size to achieve proper fixing performance, the pressurized area between the both rollers must increase. When the diameter of the pressurizing roller increases, however, the total size of an image forming apparatus must also increase. Thus, the ability to increase the size of the fixing nip is limited.

Recently, a fixing unit as shown in FIG. 1 was proposed to address the aforementioned problem. The fixing unit includes a heating roller 30 and two pressurizing rollers 10 adjacent to the heating roller 30. The heating roller 30 has a heating source (not shown) and an elastic layer 31 formed along the outer circumferential surface of the heating source. The pressuring rollers 10 are rotatably supported by a bushing 50 having grooves 50′. Also, the pressurizing rollers 10 are pressurized to the heating roller 30 by the bushing 50. An elastic body 61 is mounted between the bushing 50 and a guide structure g′, and the pressurizing rollers 10 are elastically biased toward the heating roller 30 by this elastic body 61. In this fixing unit, the size of the fixing nip is increased by providing two pressurizing rollers 10 having small diameters. However, the rigidity of the pressurizing rollers 10 is weakened by the reduction in size, and, therefore, the pressurizing rollers 10 may bend and take on a curved shape, as illustrated in FIG. 2. For explanation, the curved shape is exaggerated in FIG. 2. Referring to FIG. 2, an elastic force F is applied to both ends of the pressurizing roller 10 by the bushing 50 such that the pressurizing roller 10 presses against the heating roller 30. At this time, the pressurizing roller 10 curves and generates an uneven pressure distribution between the pressurizing roller 10 and the heating roller 30 along the longitudinal direction of the pressurizing roller. That is, since the force between both rollers 10 and 30 gradually decreases from both ends towards the center portion, the amount of compression of the elastic layer 31 and the size of the fixing nip gradually decreases from the ends towards the center portion. When the pressure between both rollers 10 and 30 varies along the axial direction, the heat and pressure applied to the print medium is uneven and thus the fixing force decreases. That is, both rollers 10 and 30 are not pressed against each other enough at the curved portion C formed in the center portion of the pressurizing roller 10 and therefore insufficient heat and pressure for fixing the image on the print medium is applied. The amount of curvature of the pressurizing roller 10 may be measured by a vertical distance e from one end to the curved portion C, and may be about 0.117 mm. In addition to print failure, excessive force is applied to the ends of the heating roller 30 and the pressurizing roller 10, and the life span of the fixing unit including the heating roller 30 is reduced.

On the other hand, the pressurizing roller 10 rotates in engagement with the heating roller 30 such that a rotation force is generated in a tangential direction of the pressurizing roller 10. At this time, an unnecessary repulsion force is generated in the pressurizing roller 10 by the bushing 50 for supporting the pressurizing roller 10 and the pressurizing roller 10 is twisted with respect to the heating roller 30 by the interaction between the rotation force and the repulsion force. Accordingly, the pressurizing roller 10 and the heating roller 30 do not contact each other with uniform pressure in the longitudinal direction and thus the elastic layer 31 therebetween is twisted. Also, the pressurizing roller 10 and the heating roller 30 are spaced apart from each other to form a gap, thereby causing an adhesion failure.

Accordingly, there is a need for an improved fixing unit with an improved pressurizing roller which has a substantially uniform nip.

### SUMMARY OF THE INVENTION

An aspect of the present invention is to address at least the above problems and/or disadvantages and to provide at least the advantages described below. Accordingly, an aspect of the present invention is to provide a fixing unit which can prevent a pressurizing roller from being deformed such that a uniform fixing nip is formed between a heating roller and the pressurizing roller, and an image forming apparatus having the same.

Another aspect of the present invention is to provide a compact fixing unit which can ensure a sufficient fixing nip and an image forming apparatus having the same.

According to an aspect of the present invention, a fixing unit for applying heat and pressure to a print medium on which a toner image is formed and fixing the toner image on the print medium is provided. The fixing unit includes a heating roller including a heating source, at least two pressurizing rollers which are sequentially pressed against the heating roller along an outer circumferential surface of the heating roller, adhesion elastic bodies which elastically pressurize the pressurizing rollers toward the heating roller at first locations of both ends of the pressurizing rollers, and correction elastic bodies which elastically pressurize the pressurizing rollers at second locations at both ends of the pressurizing rollers in the opposite direction of the adhesion elastic bodies.

The fixing unit may further include bushings which rotatably support the pressurizing rollers and pressurize the pressurizing rollers toward the heating roller. The bushings may be elastically biased by the adhesion elastic bodies and pressed against the first locations of the pressurizing rollers to pressurize the pressurizing rollers toward the heating roller.

The bushings may have plate members which face the second locations of the pressurizing rollers, and the correction elastic bodies may be interposed between the plate members and the pressurizing rollers.

The first locations to which an adhesion elastic force is applied in the longitudinal direction of the pressurizing rollers may be located inside the second locations to which a correction elastic force is applied.

The bushings may form a pair to rotatably support both ends of the pressurizing rollers. The bushings may be connected to each other by a rotation support shaft which is substantially parallel with the pressurizing rollers. The rotation support shaft may be rotatably and slidably pin-slot-jointed with a case which contains the fixing unit.

According to another aspect of the present invention, an image forming apparatus comprises an image forming unit for forming an image on a print medium and a fixing unit for fixing the image on the print medium. The fixing unit includes a heating roller including a heating source, at least two pressurizing rollers which are sequentially pressed against the heating roller along an outer circumferential surface of the heating roller, adhesion elastic bodies which elastically pressurize the pressurizing rollers toward the heating roller at first locations of both ends of the pressurizing rollers, and correction elastic bodies which elastically pressurize the pressurizing rollers at second locations at both ends of the pressurizing rollers in the opposite direction of the adhesion elastic bodies.

According to yet another aspect of the present invention, an image forming apparatus comprises an image forming unit for forming an image on a print medium and a fixing unit for fixing the image on the print medium. The fixing unit includes a heating roller including a heating source, at least two pressurizing rollers which are sequentially pressed against the heating roller along an outer circumferential surface of the heating roller; and a bushing on which the pressurizing rollers are mounted and which has a rotation support shaft. The rotation support shaft is rotatably and slidably supported to a guide wall of the image forming apparatus.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a conventional fixing unit;

FIG. 2 is a side view which illustrates a problem occurring in the fixing unit illustrated in FIG. 1;

FIG. 3 is a side view of an image forming apparatus according to an exemplary embodiment of the present invention;

FIG. 4 is an exploded perspective view of a fixing unit according to an exemplary embodiment of the present invention;

FIG. 5 is a cross-sectional view of the fixing unit illustrated in FIG. 4;

FIG. 6 is a perspective view of the rear side of the fixing unit illustrated in FIG. 4;

FIG. 7 illustrates a fixing nip formed by the fixing unit illustrated in FIG. 4; and

FIG. 8 illustrates a supporting structure of the fixing unit illustrated in FIG. 4.

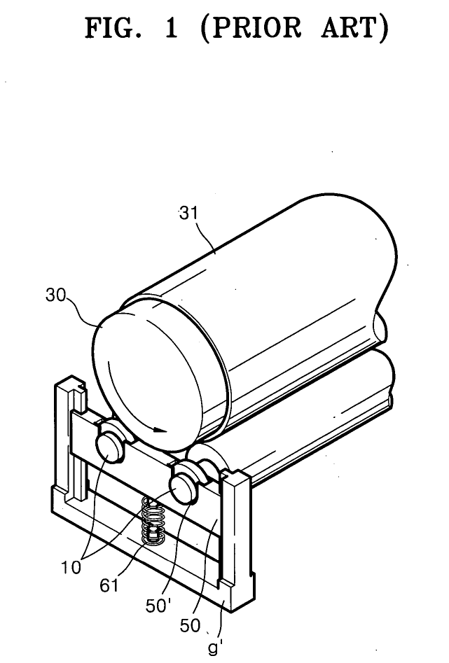

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

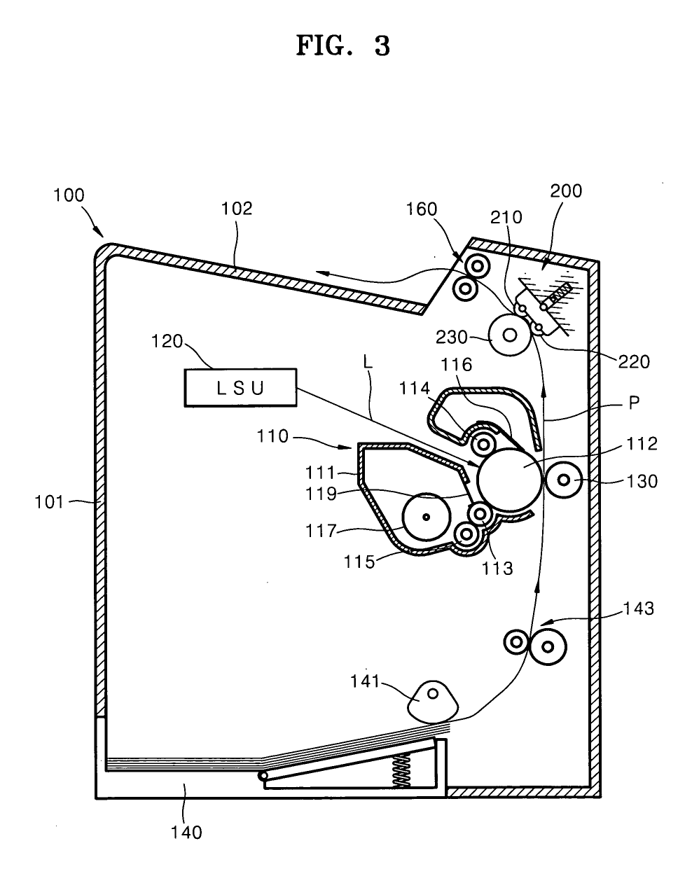

A fixing unit and an image forming apparatus having the same according to an exemplary embodiment of the present invention will now be described with reference to the accompanying drawings. FIG. 3 schematically illustrates an image forming apparatus according to an exemplary embodiment of the present invention. Referring to FIG. 3, an image forming apparatus 100 includes a case 101 for containing components, an image forming unit mounted in the case 101 for forming an image on a print medium, and a fixing unit 200 for fixing the image formed on the print medium. The image forming unit includes a light scanner 120, a developer 110, and a transfer roller 130.

The light scanner 120 scans a light beam L onto a photosensitive drum 112 along a scan line to form a latent image. The developer 110 includes the photosensitive drum 112 on which the latent image is formed on the outer circumferential surface, a charging roller 114 for charging the photosensitive drum 112, a developing roller 113 for developing the latent image on the photosensitive drum 112 using a toner, and a waste toner cleaner 116 for removing waste toner which remains on the photosensitive drum 112 after transferring a toner image to the print medium. Also, a supplying roller 115 for supplying the toner contained in a housing 111 to the developing roller 113 and a doctor blade 119 for maintaining the thickness of the toner attached to a surface of the developing roller 113 at a predetermined value are provided in the vicinity of the developing roller 113. Further, an agitator 117, which agitates the toner such that the toner does not harden, is provided in the housing 111 for containing the toner.

The transfer roller 130 contacts the photosensitive drum 112 at a predetermined pressure such that the toner image formed on the photosensitive drum 112 is transferred onto the print medium passing between the photosensitive drum 112 and the transfer roller 130. Reference letter P of FIG. 3 denotes a conveying path of the print medium. The print medium which is loaded in a feed cassette 140 is picked up one by one by a pickup roller 141 to be supplied to the transfer roller 130 through a sheet aligner 143. The sheet aligner 143 aligns the print medium such that the toner image can be transferred onto a desired portion of the print medium and feeds the print medium.

The fixing unit 200 includes a heating roller 230 and pressurizing rollers 210 and 220 which are pressed against the heating roller 230 and rotate in engagement with the heating roller 230. The fixing unit 200 fixes the toner particles on the print medium with predetermined heat and pressure while the print medium passes through the heating roller 230 and the pressurizing rollers 210 and 220. The print medium on which a visible image is fixed passes between a pair of ejection rollers 160 to be discharged to the outside of the case 101. The discharged print medium is loaded on a discharge tray 102.

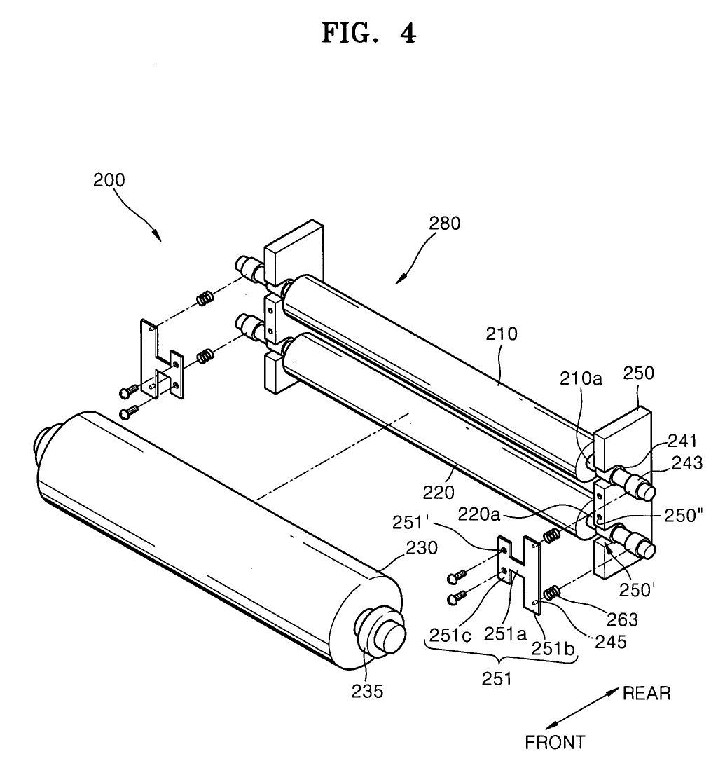

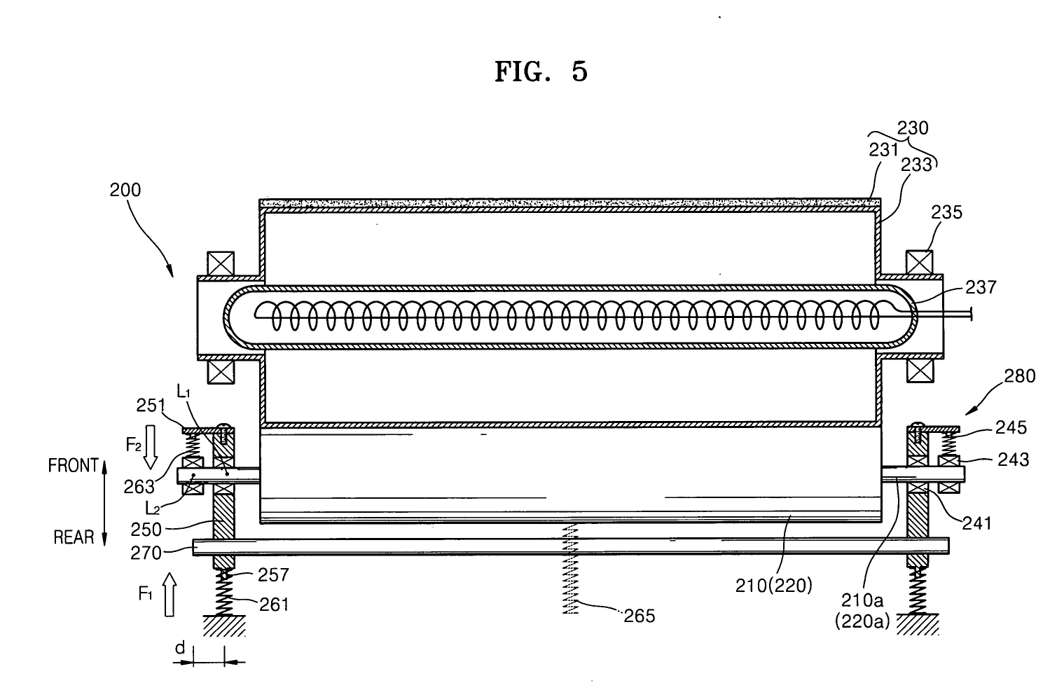

FIG. 4 is a perspective view of a fixing unit according to an exemplary embodiment of the present invention, and FIG. 5 is a cross-sectional view of the fixing unit illustrated in FIG. 4. The fixing unit 200 includes the heating roller 230 and a pressurizing roller assembly 280 which oppose each other. The pressurizing roller assembly 280 includes the pressuring rollers 210 and 220 which are elastically pressed against the heating roller 230 and bushings 250 which support the pressurizing rollers 210 and 220.

The heating roller 230 includes a heating source 237 for applying heat to the print medium onto which the toner particles are transferred. The heating source 237 may include a halogen lamp, a hot wire, and an induction heater. The heating roller 230 includes a hollow pipe 233 and an elastic layer 231 coated on the outer circumferential surface of the hollow pipe 233. The elastic layer 231 of the heating roller 230 may be made of polyurethane or silicone. The elastic layer 231 is pressed by the pressurizing rollers 210 and 220 to form fixing nips between the heating roller 230 and the pressurizing rollers 210 and 220. The elastic layer 231 may be formed on both the heating roller 230 and the pressurizing rollers 210 and 220 or on only the pressurizing rollers 210 and 220. A release layer (not shown) made of thermal-resistance wax-based material may be formed on the outside of the elastic layer 231. The release layer has good detachment properties with respect to the toner particles and may be formed on any one of, or both of, the heating roller 230 and the pressurizing rollers 210 and 220.

The heating roller 230 is rotatably supported inside the case 101 by a bearing 235, and a gear (not shown) is disposed on at least one end of the heating roller 230 as a power transferring member. By this power transferring member, the heating roller 230 is driven at a uniform rotation speed. When the heating roller 230 rotates, the pressurizing rollers 210 and 220 engaged with the heating roller 230 rotate. The fixing unit 200 according to the exemplary embodiment of the present invention includes at least two pressurizing rollers 210 and 220 which contact the outer circumferential surface of the heating roller 230. In the present exemplary embodiment, two pressurizing rollers 210 and 220 are included. The pressurizing rollers 210 and 220 are mounted on the bushings 250 through shaft portions 210a and 220a disposed at both ends thereof and rotatably supported by the bushings 250. The bushings 250 form a pair to support both ends of the pressurizing rollers 210 and 220. Each of the bushings 250 has grooves 250′ which correspond to the pressurizing rollers 210 and 220, respectively. The grooves 250′ may extend through the bushings 250, and may be formed at a predetermined vertical height. Journal bearings 241 for supporting rotation of the shaft portions 210a and 220a are mounted on the shaft portions 210a and 220a inserted into the grooves 250′.

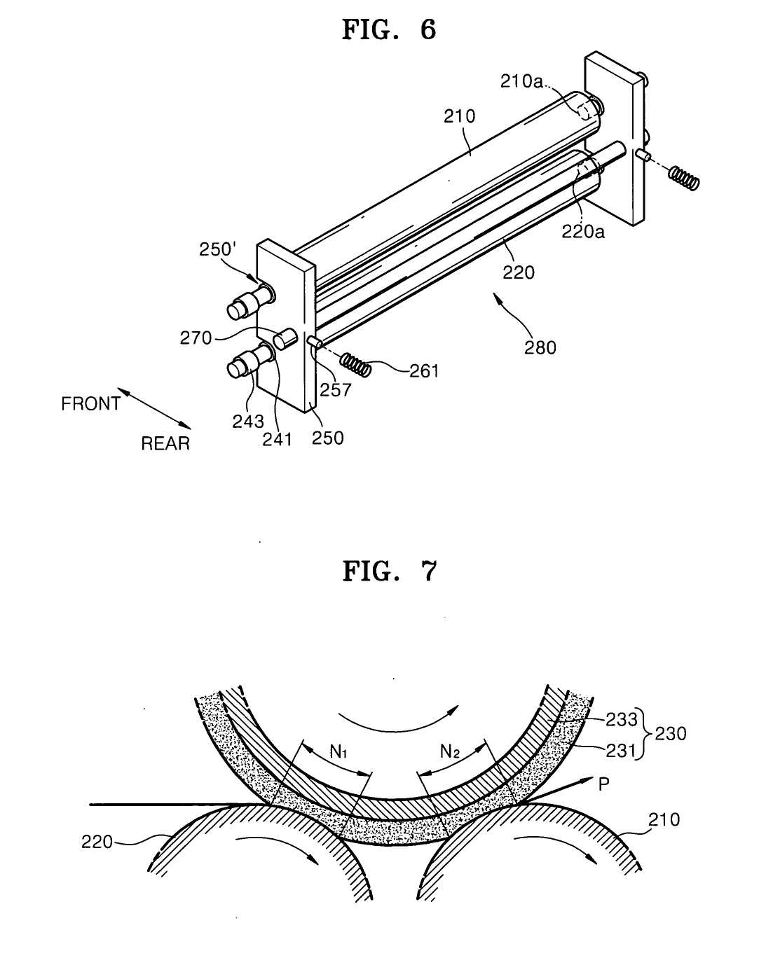

FIG. 6 is a perspective view of the rear side of the fixing unit illustrated in FIG. 4. Referring to FIG. 6, a boss 257 protrudes from the rear surface of the bushing 250 and an adhesion elastic body 261 is inserted into the boss 257. The adhesion elastic body 261 is interposed between an inner wall (not shown) of the case 101 and the bushing 250 and presses the bushing 250 toward the heating roller 230 to press the pressurizing rollers 210 and 220 mounted in the bushing 250 toward the heating roller 230. The force applied to each of the pressurizing rollers 210 and 220 varies depending on a location of the boss 257. When the boss 257 is disposed at a location having the same height difference from the pressurizing rollers 210 and 220, substantially the same force is applied to each of the pressurizing rollers 210 and 220. FIG. 7 illustrates the fixing nips N1 and N2 formed between the heating roller 230 and the pressurizing rollers 210 and 220. When the pressurizing rollers 210 and 220 are pressed toward the heating roller 230 by the adhesion elastic body 261, the elastic layer 231 is compressed to form the fixing nips N1 and N2. The print medium passes through the fixing nips N1 and N2 between the heating roller 230 and the pressurizing rollers 210 and 220 in sequence such that the toner particles attached to the print medium are fixed on the print medium by heat and pressure. Since the fixing unit 200 according to the present invention uses at least two pressurizing rollers 210 and 220, it is possible to ensure the fixing nips N1 and N2 each have a sufficient width while the apparatus remains compact. The widths of the fixing nips N1 and N2 may vary depending on the position of the boss 257. When the boss 257 is disposed at a position having the same height difference from the pressurizing rollers 210 and 220, the widths of the fixing nips N1 and N2 are substantially equal to each other.

As can be seen from FIG. 6, the bushings 250 for supporting both ends of the pressurizing rollers 210 and 220 are connected to each other through a rotation support shaft 270. The rotation support shaft 270 is disposed between the pressurizing rollers 210 and 220 which are vertically arranged, and both: ends of the rotation support shaft 270 penetrate through the bushings 250 and protrude from the bushings 250 by a predetermined length. The rotation support shaft 270 is an axis of rotation of the pressurizing roller assembly 280 and the ends thereof are slidably supported by a guide wall provided in the case 101. This will be described in detail later.

As can be seen from FIG. 4, a plate member 251 is fastened to a front side of the bushing 250. That is, the plate member 251 may be coupled to the front side of the bushing 250 by fasteners, such as screws. The plate member 251 includes a coupling portion 251c through which the screws penetrate and extensions 251a and 251b which protrude from the coupling portion 251c in a T-shape. Screw holes 250″ are formed between the grooves 250′ of the bushing 250 and penetrating holes 251′ are formed in the coupling portion 251c to correspond to the screw holes 250″. The coupling portion 251c is fixed to the front side of the bushing 250 by the screws fastened to the screw holes 250″ through the penetrating holes 251′. A first extension 251a protrudes outwardly from one side of the coupling portion 251c, and a second extension 251b extends vertically from the first extension 251a. The second extension 251b has bosses 245 that protrude backwardly from the second extension 251b. Correction elastic bodies 263 are inserted into the bosses 245.

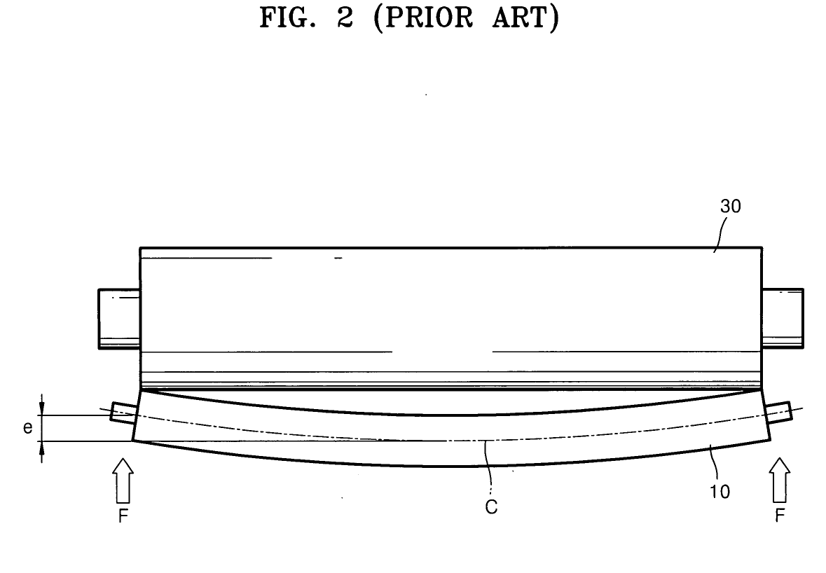

The correction elastic bodies 263 are interposed between the second extension 251b of the plate member 251 and each of the shaft portions 210a and 220a of the pressurizing rollers 210 and 220. Pressurizing bearings 243 are mounted on the shaft portions 210a and 220a corresponding to the correction elastic bodies 263. The correction elastic bodies 263 pressurize both ends of the pressurizing rollers 210 and 220 backwardly to prevent the pressurizing rollers 210 and 220 from curving. That is, since the pressurizing rollers 210 and 220 which are pressurized toward the heating roller 230 by the bushings 250 may curve, the correction elastic bodies 263 are provided to apply a force to the pressurizing rollers 210 and 220 such that the pressurizing rollers 210 and 220 are prevented from being curved. Referring to FIG. 5, an elastic force F2 is applied to second locations L2 of both ends of the pressurizing rollers 210 and 220 backwardly by the correction elastic bodies 263. The locations L2 and elastic strengths of the correction elastic bodies 263 are adequately determined such that the elastic force F1 applied to first locations L1 by the pressurizing roller is canceled, that is, such that a curvature amount e (see FIG. 2) of the pressurizing roller can be removed. Here, the second location L2 of the pressurizing roller in which the correction elastic body 263 is disposed may be spaced from the first location L1 of the pressurizing roller to which the bushing 250 is coupled by a distance d. Further, in order to prevent the pressurizing rollers 210 and 220 from being deformed, additional elastic bodies 265 may be mounted on center portions of the pressurizing rollers 210 and 220 in a longitudinal direction. With this structure, the center portions of the pressurizing rollers 210 and 220 are pressed against the heating roller 230 and thus the pressurizing rollers 210 and 220 can be prevented from being deformed.

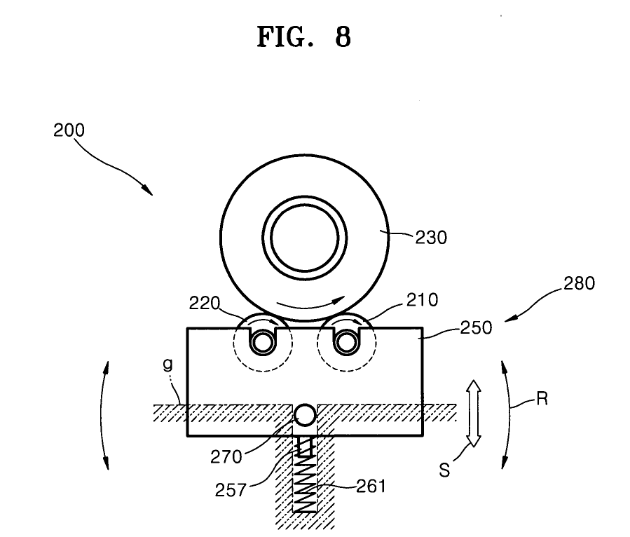

Referring to FIG. 8, the pressurizing roller assembly 280 is rotatably (R) and slidably (S) pin-slot-jointed with a guide wall g formed in the case 101 through the rotation support shaft 270. That is, the pressurizing roller assembly 280 is supported such that it rotates about the rotation support shaft 270 and moves forwardly and backwardly through the rotation support shaft 270 which slidably contacts the guide wall g. A rotation force of the heating roller 230 is applied to the contact surface between the pressurizing rollers 210 and 220 and the heating roller 230. Conventionally, an unnecessary repulsion force is caused by the bushing for supporting the pressurizing rollers, and the repulsion force twists the pressurizing rollers and the heating roller with respect to each other by a predetermined angle. Thus, the elastic layer between the both rollers is twisted and the pressurizing condition of the fixing nip varies depending on its location. In the exemplary embodiments of the present invention, since the pressurizing rollers 210 and 220 are mounted such that they slide (S) forwardly and backwardly and rotate (R) about the rotation support shaft 270, the pressurizing rollers 210 and 220 are pressed against the heating roller 230 while being freely pushed by the rotation force applied to the contact surface.

With the aforementioned fixing unit 200, the print medium onto which the toner particles are transferred passes through the first fixing nip N1 and the second fixing nip N2 between the heating roller 230 and the pressurizing rollers 210 and 220 in sequence. The pressurizing rollers 210 and 220 are prevented from being curved by the contact force, and the pressurizing rollers 210 and 220 can move along the outer circumferential surface of the heating roller 230. Accordingly, the pressurizing rollers 210 and 220 are pressed against the heating roller 230 at a uniform pressure in the longitudinal direction and the fixing nips N1 and N2 have uniform widths.

Since the fixing unit and the image forming apparatus uses at least two pressurizing rollers, sufficient fixing nips can be ensured while the apparatus remains compact. In particular, the deformation can be minimized by elastically pressurizing the pressurizing rollers having small diameters. Accordingly, it is possible to minimize fixing errors and minimize the reduction of the life span of the fixing unit due to the curve of the pressurizing rollers.

Furthermore, since the pressurizing rollers are rotatably and slidably supported, it is possible to prevent unnecessary stress on the pressurizing rollers. Accordingly, the pressurizing rollers can be pressed against the heating roller while being freely pushed and thus print quality can be improved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fixing unit for applying heat and pressure to a print medium on which a toner image is formed and fixing the toner image on the print medium, comprising:
a heating roller comprising a heating source;
at least two pressurizing rollers which are pressed against the heating roller along an outer circumferential surface of the heating roller;
adhesion elastic bodies which elastically press the pressurizing rollers toward the heating roller at first locations of both ends of the pressurizing rollers; and
correction elastic bodies which elastically press the pressurizing rollers at second locations of both ends of the pressurizing rollers in the opposite direction as the adhesion elastic bodies.

2. The fixing unit according to claim 1, further comprising bushings for rotatably supporting the pressurizing rollers and pressing the pressurizing rollers toward the heating roller.

3. The fixing unit according to claim 2, wherein the bushings are elastically biased by the adhesion elastic bodies and contact the first locations of the pressurizing rollers to press the pressurizing rollers toward the heating roller.

4. The fixing unit according to claim 2, wherein the bushings comprise plate members which face the second locations of the pressurizing rollers, and the correction elastic bodies are interposed between the plate members and the pressurizing rollers.

5. The fixing unit according to claim 2, wherein the bushings form a pair to rotatably support both ends of the pressurizing rollers and the bushings are connected to each other by a rotation support shaft which is substantially parallel to the pressurizing rollers.

6. The fixing unit according to claim 5, wherein the rotation support shaft is rotatably and slidably disposed on a case which contains the fixing unit.

7. The fixing unit according to claim 1, wherein the first locations to which an adhesion elastic force is applied in the longitudinal direction of the pressurizing rollers are located inside the second locations to which a correction elastic force is applied.

8. An image forming apparatus comprising an image forming unit for forming an image on a print medium and a fixing unit for fixing the image on the print medium, the fixing unit comprising:
a heating roller comprising a heating source;
at least two pressurizing rollers which are pressed against the heating roller along an outer circumferential surface of the heating roller;
adhesion elastic bodies which elastically press the pressurizing rollers toward the heating roller at first locations of both ends of the pressurizing rollers; and
correction elastic bodies which elastically press the pressurizing rollers at second locations of both ends of the pressurizing rollers in the opposite direction as the adhesion elastic bodies.

9. The image forming apparatus according to claim 8, further comprising bushings for rotatably supporting the pressurizing rollers and pressing the pressurizing rollers toward the heating roller.

10. The image forming apparatus according to claim 9, wherein the bushings are elastically biased by the adhesion elastic bodies and contact the first locations of the pressurizing rollers to press the pressurizing rollers toward the heating roller.

11. The image forming apparatus according to claim 9, wherein the bushings comprise plate members which face the second locations of the pressurizing rollers, and the correction elastic bodies are interposed between the plate members and the pressurizing rollers.

12. An image forming apparatus comprising an image forming unit for forming an image on a print medium and a fixing unit for fixing the image on the print medium, the fixing unit comprising:
a heating roller comprising a heating source;
at least two pressurizing rollers which are pressed against the heating roller along an outer circumferential surface of the heating roller; and
a bushing on which the pressurizing rollers are mounted and which has a rotation support shaft,
wherein the rotation support shaft is rotatably and slidably supported by a guide wall of the image forming apparatus.

13. The image forming apparatus according to claim 12, wherein the rotation support shaft is rotatably and slidably pin-slot-jointed on the guide wall.

14. The image forming apparatus according to claim 12, wherein the bushing is supported to move along the outer circumferential surface of the heating roller together with the pressurizing rollers.

15. The image forming apparatus according to claim 12, wherein the bushing is supported to slide with respect to the heating roller forwardly and backwardly.

16. The image forming apparatus according to claim 12, wherein the bushing is supported to rotate in a forward and reverse rotation direction of the heating roller.

17. A fixing unit for fixing a toner image onto a print medium in an image forming apparatus, comprising:
a heating roller;
at least two pressurizing rollers pressed against the heating roller;
pressing means for pressing the pressurizing rollers against the heating roller; and
preventing means for preventing bending of the pressurizing rollers.

18. The fixing unit according to claim 17, further comprising bushings for rotatably supporting the pressurizing rollers.

19. The fixing unit according to claim 18, wherein the pressing means comprises elastic bodies that press the bushings toward the heating roller.

20. The fixing unit according to claim 19, wherein the preventing means comprises correction elastic bodies which press the pressurizing rollers in the opposite direction as the pressing means at a different location than the pressing means.

21. The fixing unit according to claim 20, wherein the preventing means is disposed on the bushings.

22. The fixing unit according to claim 20, further comprising plate members disposed on the bushings for supporting the correction elastic bodies.

23. The fixing unit according to claim 18, further comprising a rotation support shaft extending between the bushings.

24. The fixing unit according to claim 23, wherein the rotation support shaft is rotatably and slidably supported by a case containing the fixing unit.
